(19) United States
(12) Patent Application Publication
(10) Pub. No.: US 2014/0307080 A1
(43) Pub. Date: Oct. 16, 2014

(54) CRYSTALLIZED SAMPLE INSPECTION APPARATUS

(71) Applicant: SAMSUNG DISPLAY CO., LTD., Yongin-City (KR)

(72) Inventors: Ki-Hyun KIM, Yongin-City (KR); Young-Gil PARK, Yongin-City (KR); Shang-U KIM, Yongin-City (KR); Ki-Won OH, Yongin-City (KR)

(21) Appl. No.: 14/056,191

(22) Filed: Oct. 17, 2013

(30) Foreign Application Priority Data
Apr. 11, 2013 (KR) 10-2013-0040036

(51) Int. Cl. G01N 21/95

(52) U.S. Cl. CPC G01N 21/95
USPC 348/86; 356/445; 356/51

(57) ABSTRACT

A sample inspection apparatus is provided. A sample inspection apparatus according to an exemplary embodiment of the present invention includes a base; a loading portion installed on the base so that a sample is placed thereon; a first light source radiating light on the sample, the sample being placed on the loading portion; a first light receiving portion located at a first position and receiving light reflected and scattered by the sample; and a support portion positioned on the loading portion so that the first light source and the first light receiving portion are movably installed on the support portion.

### CLAIM PRIORITY

This application makes reference to, incorporates the same herein, and claims all benefits accruing under 35 U.S.C. §119 from an application for CRYSTALLIZED SAMPLE INSPECTION APPARATUS, earlier filed in the Korean Intellectual Property Office on Apr. 11, 2013, and there duly assigned Serial No. 10-2013-0040036.

### BACKGROUND OF THE INVENTION

1. Field of the Invention

The described technology relates generally to a crystallized sample inspection apparatus.

2. Description of the Related Art

An organic light emitting diode display is a self-light emitting display device displaying an image by using an organic light emitting diode emitting light.

A thin film transistor, a capacitor, and the like used in the organic light emitting diode display often include a polysilicon layer prepared using deposition and doping techniques particular to the application. Herein, the characterization through the use of a crystallized sample inspection apparatus of a polysilicon layer made by a method of polycrystallizing an amorphous silicon layer is described. The amorphous silicon layer may be polycrystallized through various known methods to form the subject polysilicon samples.

Among polycrystallization methods, an excimer laser annealing (ELA) method can be used to polycrystallize an amorphous silicon layer at relatively low temperatures and can form a polysilicon layer having an excellent characteristic of a relatively high electron mobility, and thus this method is being extensively used. In the excimer laser annealing (ELA) method, a line type excimer laser beam is scanned and radiated over an amorphous silicon layer surface to polycrystallize the amorphous silicon layer.

When the ELA method is used, stains may be formed in the silicon layer polycrystallized during the excimer laser annealing process, and thus an apparatus for inspecting the polycrystallized silicon layer is required.

The above information disclosed in this Background section is only for enhancement of understanding of the background of the described technology and therefore it may contain information that does not form the prior art that is already known to a person of ordinary skill in the art.

### SUMMARY OF THE INVENTION

Embodiments of the present invention provide a crystallized sample inspection apparatus in which an absolute quantification of a crystallization stain, a crystallization degree, and a thickness may be obtained by measurement of a transmittance, a scattering ratio, and a reflectivity, these measurements being independent of equipment state, measurement time, and sample type.

An exemplary embodiment of the present invention provides a sample inspection apparatus including: a base; a loading portion installed on the base so that a sample may be placed thereon; a first light source radiating light on the sample, the sample being placed on the loading portion; a first light receiving portion located at a first position and receiving light reflected and scattered by the sample; and a support portion positioned on the loading portion so that the first light source and the first light receiving portion are movably installed on the support portion.

In this embodiment, the support portion may include a circular arc type support fixture disposed such that the center of the support fixture is vertically above the loading portion on which the sample is placed, the sample being placed at the center of the loading portion, and the first light source and the first light receiving portion may be movably installed on the circular arc type support fixture.

In this embodiment, the sample inspection apparatus may further include a second light receiving portion located at a second position, the second light receiving portion receiving the light reflected and scattered by the sample, and the second light receiving portion may be movably installed on the circular arc type support fixture.

In this embodiment, the sample inspection apparatus may further include a camera installed on the support portion to photograph an image of a surface of the sample.

In this embodiment, the camera may be positioned to move together with the first light receiving portion along the arc of the support fixture.

In this embodiment, the first light receiving portion and the camera may be disposed at a central portion of the circular arc type support fixture in a position that is vertically above the base.

In this embodiment, the sample inspection apparatus may further include a three dimensional positioner located between the base and the loading portion so that the loading portion moves in any direction along one or more of the three orthogonal dimensions including a vertical dimension and two mutually perpendicular horizontal dimensions parallel to the base.

In this embodiment, the horizontal dimensions may be parallel to the base and mutually perpendicular.

In this embodiment, the sample inspection apparatus may further include a second light source installed beneath the sample on the loading portion, the second light source radiating light that passes through the sample.

In this embodiment, the light may include wavelength bands of a UV region, a visible spectral region, and an IR spectral region.

In this embodiment, the first light receiving portion and the second light receiving portion may independently select a predetermined region of the wavelengths of the UV region, the visible spectral region, and the IR spectral region to measure at least one of reflectivity, a scattering ratio, and transmittance intensity, the measurements facilitating a comparison of spectrum shapes.

The sample inspection apparatus may further include an optical microscope installed on one of the first light receiving portion and the second light receiving portion.

In this embodiment, the sample inspection apparatus may further include an angle adjustment member installed on the support fixture so that an angle of incidence upon the sample of the light from the first light source is capable of being adjusted.

In this embodiment, the sample inspection apparatus may further include an attachment including a slit, the attachment being capable of being attached to and detached from a front of the light source, to adjust the magnitude of the light.

According to an exemplary embodiment of the present invention, a sample inspection apparatus may measure absolute reflectivity, scattering ratio, and transmittance using a standard sample.

In the sample inspection apparatus according to the exemplary embodiment of the present invention, a light source and a light receiving portion are integrally equipped in a fixed support fixture, and thus measurement conditions may be reproduced as needed and it may be convenient to maintain and manage equipment.

Further, in the sample inspection apparatus according to the exemplary embodiment of the present invention, an optical microscope may be installed on one of the first light receiving portion and the second light receiving portion. Thus, an observation region may be freely changed to a micro scale, and the sample may be evaluated therein.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a sample inspection apparatus according an exemplary embodiment of the present invention.

FIG. 2 is a flowchart of a sample inspection method using the sample inspection apparatus according to the exemplary embodiment of the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive Like reference numerals designate like elements throughout the specification.

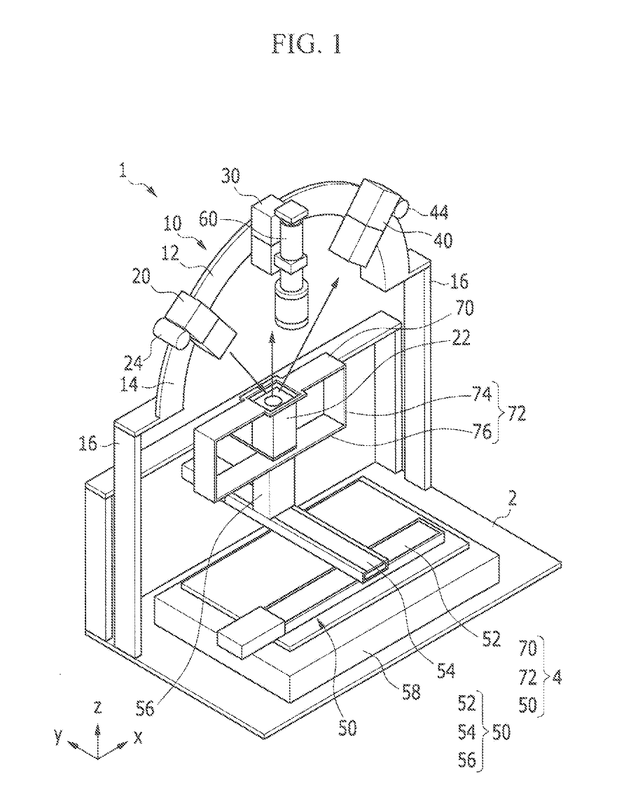

FIG. 1 is a perspective view of a sample inspection apparatus 1 according an exemplary embodiment of the present invention.

Referring to FIG. 1, the sample inspection apparatus 1 according to the exemplary embodiment of the present invention may include a base 2, a support portion 10, a loading portion 4, a camera 60, a first light source 20, a second light source 22, a first light receiving portion 30, and a second light receiving portion 40.

The base 2 may be a means for placing the sample inspection apparatus according to the exemplary embodiment of the present invention on a supporting surface, and may be formed of a plate type member.

The loading portion 4 may be positioned on the base 2 so that a sample can be placed thereon.

The loading portion 4 includes a stage 70 on which an inspection target sample can be placed, a stage support fixture 72 supporting the stage 70, and a three dimensional positioner 50 for moving the stage 70.

The stage 70 may comprise a plate in which an opening is formed at a position on which the inspection target sample may be placed.

Referring to FIG. 1, the stage 70 may extend in an x-axis direction, and the stage support fixture 72 for supporting the stage 70 may be installed to connect with stage 70 at either end of the stage 70.

The stage support fixture 72 may include a pair of first support fixtures 74 extending toward the base from both ends of the stage 70, and a second support fixture 76 extending in a horizontal direction parallel to the base so that lower side ends of a pair of first support fixtures 74 are connected.

In this embodiment, the second support fixture 76 may be spaced apart from the stage 70 by a height of the first support fixtures 74, and may be arranged in parallel to the stage 70.

The three dimensional positioner 50 for moving the stage 70 and the stage support fixture 72 in x-axis, y-axis, and z-axis directions may be installed at a lower portion of the second support fixture 76 as seen in the view of FIG. 1. In this embodiment, the three dimensional positioner 50 may include a first horizontal guide 52, a second horizontal guide 54 arranged perpendicular to first horizontal guide 52, and a vertically moving member 56.

The first horizontal guide 52 may be a guide member arranged to extend in an x-axis direction on the base 2. In this embodiment, the first horizontal guide 52 may be a known guide member such as a LM guide, but is not limited thereto.

In this embodiment, a separate support member 58 may be further installed at a lower side of the first horizontal guide 52 in order to support the first guide 52 on the base.

Meanwhile, the second horizontal guide 54 may be a guide member that moves in concert with the first horizontal guide 52 so that the stage 70 may be moved to any combination of positions along the x-axis direction and along the y-axis direction. The second horizontal guide 54 may be a known guide member such as the LM guide like the first horizontal guide 52.

The vertically moving member 56 may be installed on the second horizontal guide 54 to move the stage 70 and the stage support fixture 72 in the z-axis direction.

The three dimensional positioner 50 moving the stage 70 and the stage support fixture 72 in three axis directions may be constructed using various known moving members.

A support portion 10 may be installed on the base 2.

The support portion 10 may include a circular arc type support fixture 12 disposed to be vertical to the loading portion 4 on which the sample is placed, the sample being placed on the stage 70, which is located at the center of loading portion 4.

The first light source 20, the first light receiving portion 30, and the second light receiving portion 40 may be movably installed in the circular arc type support fixture 12. The circular arc type support fixture 12 may include a circular arc type guide portion 14 and may be attached to a circular arc type guide portion support fixture 16 so that the first light source 20, the first light receiving portion 30, and the second light receiving portion 40 can be movably installed on the circular arc type support fixture 12.

For example, a rack (not shown) may be installed in the circular arc type guide portion 14, and a pinion (not shown) may be installed in the first light source 20, the first light receiving portion 30, and the second light receiving portion 40 so that the first light source 20, the first light receiving portion 30, and the second light receiving portion 40 can be movably installed at any desired position along the circular arc type guide portion 14.

Accordingly, the first light source 20, the first light receiving portion 30, and the second light receiving portion 40 may be each movably located along the circular arc type guide portion 14.

The first light source 20 may radiate light to a sample placed on the stage 70.

In this embodiment, light radiated from the first light source 20 may be selected to have a wavelength band of a UV region, a visible spectral region, and an IR spectral region.

As described above, since the light incident upon the sample may include wavelength bands corresponding to the UV region, the visible spectral region and the IR spectral region, the UV wavelengths absorbed by the sample may provide information regarding a crystallization degree, reflection or absorption of visible light wavelengths may be useful for evaluating stains, and reflection of IR wavelengths may be used to determine a thickness of the sample.

A first angle adjustment member 24 may allow the position of the first light source 20 along the circular arc type guide portion 14 to be fixed so that a radiation angle of incidence upon the sample may be adjusted to a desired setting.

In this embodiment, the first angle adjustment member 24 may be formed of a cylindrical member concentric-axially combined with the pinion, which is movably combined with the rack of the circular arc type guide portion 14.

The first light source 20 may be constructed so that the angle that light from the first light source 20 forms with stage 70 may be adjusted in a coarse way such that movement of light source 20 along circular arc type guide portion 14 is independent of rotation of the pinion.

Accordingly, the first light source 20 may radiate light on the surface of the sample at an angle of about 10 to 85° to a flat surface on which the sample is placed.

In this embodiment, an attachment including a slit having a predetermined width may be installed to be attached to and detached from the front of the first light source 20 so that the magnitude of light of the first light source 20, that is, a radiation width of light, may be adjusted. As described above, since configurations of the slit that may be useful for adjusting the width of radiated light are known, a detailed description thereof will be omitted.

When the apparatus of the present invention is operated, light radiated from the first light source 20 may be reflected or scattered by the sample placed on the stage 70.

As described above, the first light receiving portion 30 and the second light receiving portion 40 may be installed in locations along the arc of the circular arc type support fixture 12 in order to receive light reflected and scattered by the sample.

In this embodiment, the first light receiving portion 30 may be positioned at the central portion of the circular arc type support fixture 12 directly over the sample, that is, in a direction that extends from the sample location vertically and perpendicular to the base 2.

In addition, the camera 60 may be combined with the first light receiving portion 30 and may therefore be in position to photograph the sample from the same perspective as observed by the first light receiving portion 30.

The camera 60 may be located adjacent to the first light receiving portion 30 and may move along the circular arc type guide portion 14 together with the first light receiving portion 30. In this embodiment, the camera 60 may be a CCD camera.

The camera 60 may photograph the crystallized sample to monitor a crystallization state of the sample and confirm crystallization stains of the sample.

In certain embodiments, the second light receiving portion 40 may be positioned on a side of circular arc type guide portion 14 that is opposite to the side on which the first light source is positioned, while the first light receiving portion 30 may be positioned at the center of the circular arc type guide portion 14.

In this embodiment, the second light receiving portion 40 may be installed in the circular arc type guide portion by a second angle adjustment member 44 such that second light receiving portion 40 may be moved along circular arc type guide portion 14 and fixed at a desired position thereon. Since the second angle adjustment member 44 may be identically constituted in respect to the first angle adjustment member 24, a detailed description thereof will be omitted.

In this embodiment, the first light receiving portion 30 and the second light receiving portion 40 may include a spectrometer that may receive light reflected or scattered by the sample, select a predetermined region of wavelengths of light, such as a UV region, a visible spectral region, or an IR spectral region, and measure at least one of reflectivity, scattering ratio and transmittance intensity (area ratio or peak intensity), optionally comparing spectrum shapes.

In this embodiment, an optical microscope may be installed on one of the first and second light receiving portions 30 and 40 to observe an observation region on a micro scale.

The sample inspection apparatus 1 according to the exemplary embodiment of the present invention may further include a second light source 22 positioned beneath the sample.

The second light source 22 may be positioned in a space between the stage 70 and the stage support fixture 72 to emit light that irradiates the lower side of the sample.

As described above, light radiated from the second light source 22 may pass through the sample, and thus light that is transmitted through the sample may be received in the first light receiving portion 30.

The second light source 22 may be configured to move together with the stage 70, and, even though a position of the stage 70 is changed, a position of the second light source 22 relative to the sample is not changed.

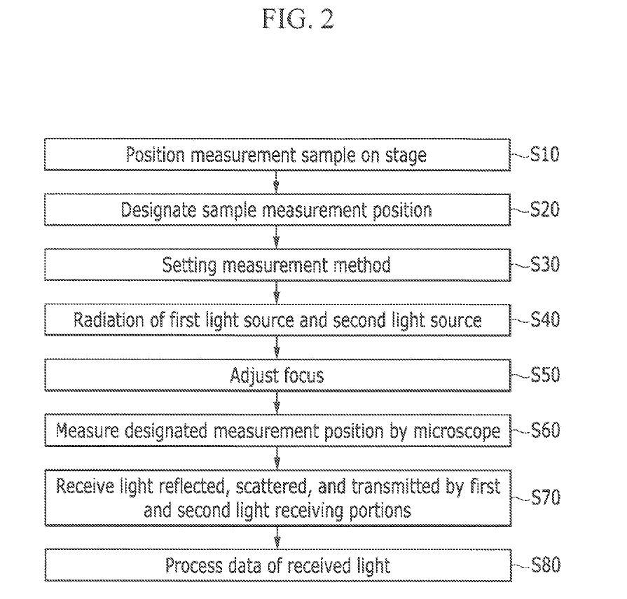

A sample inspection method using the sample inspection apparatus 1 having the aforementioned constitution will be described with reference to FIG. 2.

FIG. 2 is a flowchart of a sample inspection method using the sample inspection apparatus according to the exemplary embodiment of the present invention.

Referring to FIG. 2, a sample to be measured is first positioned on a stage (S10).

Thereafter, a measurement position for measuring the sample is designated (S20).

When the measurement position of the sample is designated, a measurement method for measuring the sample is set (S30).

In this embodiment, a setting condition of the measurement method for measuring the sample, for example, may include selecting the data to be measured, for example, reflectivity, scattering ratio, transmittance intensity (area ratio or peak intensity), selecting a wavelength range of the light source, selecting a position of a first light source 20 along circular arc type guide portion 14, positions of a first light receiving portion 30 and a second light receiving portion 40 along circular arc type guide portion 14, and the like.

As described above, if setting of the measurement conditions to be used with the sample is finished, the first light source 20 and the second light source 22 may be activated to radiate light to the sample (S40).

Thereafter, a stage 70 is moved up or down using vertically moving member 56 to adjust the focus so that light is radiated on the sample (S50).

As described above, a microscope in a designated measurement position may be used to acquire spectral data when the irradiated light is focused upon the sample (S60).

In addition, light reflected, scattered, and transmitted by the sample may be received by the first and second light receiving portions 30 and 40 (S70).

Inspection may be finished by processing data collected by the first and second light receiving portions 30 and 40 to obtain information regarding the sample (S80).

The sample inspection apparatus 1 according to an exemplary embodiment of the present invention may inspect a reference sample before an inspection target sample is inspected and thereby obtain quantified results that are independent of a measurement time through comparison of data obtained from the inspection target sample with data obtained from the reference sample.

Accordingly, absolute quantification of a crystallization stain, a crystallization degree, and a thickness of the sample is feasible by using reflectivity, transmittance, and scattering ratio as obtained by the sample inspection apparatus 1 according to an exemplary embodiment of the present invention.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | | | |
|---|---|---|---|
| 1 | Sample inspection apparatus | 2 | Base |
| 4 | Loading portion | 10 | Support portion |
| 12 | Circular arc type support | 14 | Circular arc type guide portion |
| | fixture | | |
| 16 | Guide portion support fixture | 20 | First light source |
| 22 | Second light source | 24 | First angle adjustment member |
| 30 | First light receiving portion | 40 | Second light receiving portion |
| 44 | Second angle adjustment | 50 | Three dimensional positioner |
| | member | | |
| 52 | First horizontal guide | 54 | Second horizontal guide |
| 56 | Vertically moving member | 60 | camera |
| 70 | Stage | 72 | Stage support fixture |
| 74 | First support fixture | 76 | Second support fixture |

What is claimed is:

1. A sample inspection apparatus comprising:
a base;
a loading portion installed on the base so that a sample is placed thereon;
a first light source radiating light on the sample, the sample being placed on the loading portion;
a first light receiving portion located at a first position and receiving light reflected and scattered by the sample; and
a support portion positioned on the loading portion so that the first light source and the first light receiving portion are movably installed on the support portion.

2. The sample inspection apparatus of claim 1,
the support portion including a circular arc type support fixture disposed to be vertically above the loading portion, the sample being placed at the center of the loading portion, and
the first light source and the first light receiving portion being movably installed on the circular arc type support fixture.

3. The sample inspection apparatus of claim 2, further comprising:
a second light receiving portion located at a second position, the second light receiving portion receiving the light reflected and scattered by the sample,
the second light receiving portion being movably installed on the circular arc type support fixture.

4. The sample inspection apparatus of claim 1, further comprising:
a camera installed on the support portion to photograph an image of a surface of the sample.

5. The sample inspection apparatus of claim 4,
the camera being positioned to move together with the first light receiving portion.

6. The sample inspection apparatus of claim 5,
the first light receiving portion and the camera being disposed at a central portion of the circular arc type support fixture in a position that is vertically above the base.

7. The sample inspection apparatus of claim 1, further comprising:
a three dimensional positioner located between the base and the loading portion so that the loading portion moves in any direction along one or more of three orthogonal dimensions including a vertical dimension and two horizontal dimensions.

8. The sample inspection apparatus of claim 7,
the horizontal dimensions being parallel to the base and mutually perpendicular.

9. The sample inspection apparatus of claim 1, further comprising:
a second light source installed beneath the sample on the loading portion, the second light source radiating light that passes through the sample.

10. The sample inspection apparatus of claim 1,
the light including wavelength bands of a UV region, a visible spectral region, and an IR spectral region.

11. The sample inspection apparatus of claim 3,
the first light receiving portion and the second light receiving portion independently selecting a predetermined region of the wavelengths of the UV region, the visible spectral region, and the IR spectral region to measure at least one of reflectivity, a scattering ratio, and transmittance intensity, the measurements facilitating a comparison of spectrum shapes.

12. The sample inspection apparatus of claim 3, further comprising:
an optical microscope installed on one of the first light receiving portion and the second light receiving portion.

13. The sample inspection apparatus of claim 1, further comprising:
an angle adjustment member installed on the support fixture so that an angle of incidence upon the sample of the light from the first light source is capable of being adjusted.

14. The sample inspection apparatus of claim 1, further comprising:
an attachment including a slit, the attachment being capable of being attached to and detached from a front of the first light source, to adjust the magnitude of the light.
